(19) United States
(12) Patent Application Publication
(10) Pub. No.: US 2013/0300119 A1
(43) Pub. Date: Nov. 14, 2013

(54) WASTE BIN HAVING A CONVERTER FOR CONVERTING MECHANICAL ENERGY INTO ELECTRICAL ENERGY

(71) Applicants: Claudio Anzalone, Forli' (IT); Daniele Giunchi, Forli' (IT); Paolo Paoli, Ferrara (IT)

(72) Inventors: Claudio Anzalone, Forli' (IT); Daniele Giunchi, Forli' (IT); Paolo Paoli, Ferrara (IT)

(73) Assignee: HERA S.P.A., Bologna (IT)

(21) Appl. No.: 13/988,068

(22) PCT Filed: Nov. 23, 2010
(86) PCT No.: PCT/IT2010/000469

§ 371 Date: Jul. 30, 2013

(51) Int. Cl. B65F 1/16; H02K 7/18

(52) U.S. Cl. CPC B65F 1/16; H02K 7/18
USPC 290/50

(57) ABSTRACT

A waste bin including an upper opening for the depositing of waste into an internal compartment for containment is provided. The opening is delimited by at least one respective closing door leaf. The bin includes at least one control unit for commanding respective sensors and operative assemblies, at least one battery for powering the control unit and the circuits controlled by it, and at least one converter for converting mechanical energy into electrical energy which has output terminals connected to the battery for its recharging. The movement of at least a portion of the bin, for use, emptying and maintenance, causes the activation of the converter and the recharging of the at least one battery.

### TECHNICAL FIELD

The present invention relates to a bin for the activity of waste control and management.

### BACKGROUND ART

Companies operating in the collection and disposal of waste need to optimise their work cycles and to have collected material that is as homogeneous as possible.

So firstly, it would be essential to know the levels of the bins in the entire waste collection area in order to establish the most efficient collection route.

Therefore, each bin should include elements for detecting the degree of filling reached by the waste inside it and suitable devices for transmitting this information to a suitable operations centre.

It is obvious that this would require an electrical power source, associated with the bin, that ensures the operation of all the electric and electronic components.

However, it is not always possible to connect the bin to the mains electricity supply, since such a connection would create difficulties during the emptying step (when the waste collection truck lifts the bin and tips it into its collection hopper).

It may also be necessary to check whether the waste deposited by the user conforms to the collection being conducted (in order to optimise the differentiation of such collection).

In this case, each user could have their own identification card (provided with a chip, magnetic strip, transponder etc.) which associates the deposited waste with that user.

In this way it would be possible to verify and, store all of the deposits that diverge from the standard.

These activities require the presence of electronic components in the bin, and such components require an adequate electric power supply.

In this specific case, it could be the waste collection truck that extracts the stored information with each emptying procedure; the bin would however still require a power source in order for its electronic accessories to function.

It has already been considered to equip the bins with batteries of accumulators of electrical energy that can power all the components and the electrical and electronic assemblies installed therein.

Unfortunately the duration of charging, since the batteries used are unobtrusive and light, is often insufficient and requires continual and frequent recharging operations which make this solution not very convenient in terms of cost.

An alternative is known which involves the use of large batteries which, for example, extend over the entire bottom of the bin or its walls, thus ensuring a continuous and long-lasting operation which perfectly meets the applicative requirements.

The consequence of adopting this type of battery is the considerable increase in weight of the bin and a reduction of the internal volume for collecting waste.

Of no lesser importance is the fact that large-sized batteries of accumulators also have an extremely high purchase cost.

### DISCLOSURE OF THE INVENTION

The aim of the present invention is to solve the above-mentioned problems, by providing a bin for the activity of waste control and management which does not require specific recharging operations and is therefore substantially autonomous in terms of electricity.

Within this aim, an object of the invention is to provide a bin for the activity of waste control and management which is low-weight.

Another object of the invention is to provide a bin for the activity of waste control and management which has a large internal volume.

A further object of the present invention is to devise a bin for the activity of waste control and management that is low-cost, relatively easy to implement in practice and safe in application.

This aim and these objects, as well as others which will become better apparent hereinafter, are achieved by a bin for the activity of waste control and management, of the type that comprises an upper opening for the depositing of waste into an internal compartment for containment, said upper opening being delimited by at least one respective closing door leaf, characterized in that it comprises at least one management and control unit for commanding respective sensors and operative assemblies, at least one battery for powering said unit and the circuits controlled by it, and at least one converter for converting mechanical energy into electrical energy which has output terminals connected to said battery for its recharging, the movement of at least a portion of said bin for use, emptying and maintenance thus causing the activation of said converter and the recharging of said at least one battery.

### BRIEF DESCRIPTION OF THE DRAWINGS

Further characteristics and advantages of the invention will become better apparent from the detailed description that follows of a preferred, but not exclusive, embodiment of the bin for the activity of waste control and management according to die invention, illustrated by way of non-limiting example in the accompanying drawings, wherein:

FIG. 1 is a schematic perspective view of a bin for the activity of waste control and management, according to the invention;

FIG. 2 is a schematic view of a first possible converter for converting mechanical energy into electrical energy for a bin for the activity of waste control and management according to the invention;

FIG. 3 is a schematic view of a second possible converter for converting mechanical energy into electrical energy for a bin for the activity of waste control and management according to the invention;

FIG. 4 is a schematic view of a third possible converter for converting mechanical energy into electrical energy for a bin for the activity of waste control and management according to the invention.

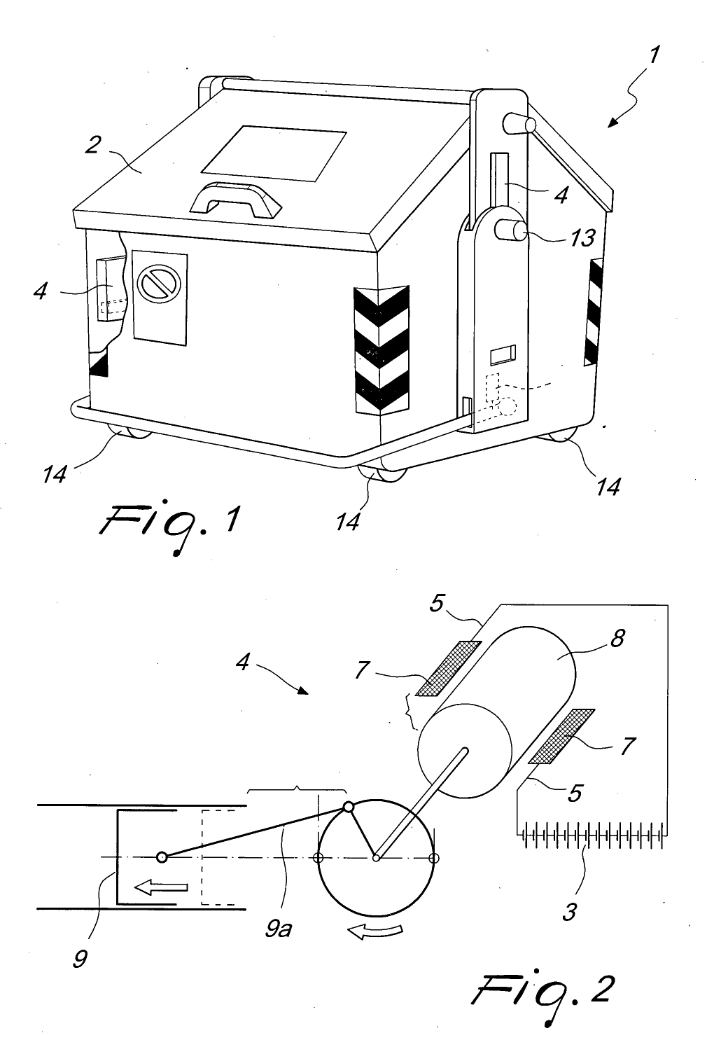

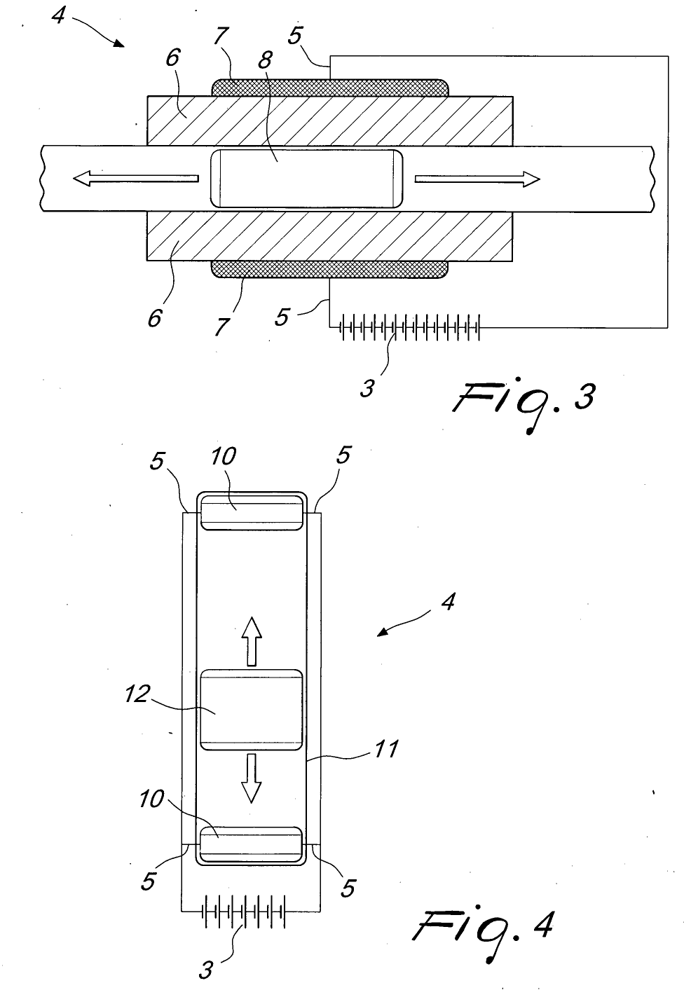

### WAYS OF CARRYING OUT THE INVENTION

With reference to the figures, the reference numeral 1 generally indicates a bin for the activity of waste control and management.

The bin 1 comprises an upper opening for the depositing of waste into the internal compartment for containment; this opening is delimited by at least one respective closing door leaf 2.

The bin 1 furthermore comprises at least one management and control unit for commanding respective sensors and operative assemblies, at least one battery 3 for powering the unit and the circuits controlled by it, and at least one converter 4 for converting mechanical, energy into electrical energy which has output terminals 5 connected to the battery 3 for its recharging.

Indeed, the movement of at least a portion of the bin 1 (and/or of any accessory components applied to it), this movement being produced by normal use (opening and closing of the door leaf 2 for depositing waste), by emptying and by maintenance, causes the activation of the converter 4 and the recharging of the battery 3.

According to a possible embodiment of undoubted practical and applicative interest, the converter 4 for converting mechanical energy into electrical energy comprises a static component which is integral with the bin 1 and is provided with a circuit 6 made of ferromagnetic material on which an electrical winding 7 is installed, and a dynamic component which is constituted by a magnet 8 which is movable inside a respective cavity of the ferromagnetic circuit 6 of the static component.

During a movement of the bin 1 for use, emptying and maintenance the dynamic component is caused to move with respect to the static component with consequent electromagnetic induction in the electrical winding 7 and establishment of a voltage at the terminals 5 of the winding 7.

In turn the terminals 5 are connected to the battery 3 for its recharging.

It should be noted that the scope of the present invention is intended to also cover the solution whereby the arrangement of the components is inverted, i.e. a fixed magnet and a magnetic circuit which is provided with respective windings and is movable with respect to the magnet. Such inversion produces the same technical effect by adoption of the same components, which are arranged in a configuration that is clearly equivalent to the one described previously.

It should be noted that the movable magnet 8 could be constituted by a slider which is, adapted for linear translational movement, according to a consecutive motion of advancement and retraction, inside the cavity of the static component.

The translational movement of the movable magnet 8 produces a variation in the magnetic flux with consequent induction of a voltage at the terminals 5 of the winding 7.

According to another embodiment, which is equally interesting from a practical point of view, the movable magnet 8 is a rotor that is adapted to rotate, about its own axis, inside the cavity that is defined by the static component.

In this case the rotation produces a variation in the magnetic flux with consequent induction of a voltage at the ends of the winding 7.

With particular reference to the two embodiments described previously, Faraday's law of induction holds that the electromotive force (the voltage at the terminals 5, in this case) induced in a closed circuit by a magnetic field is equal to the opposite of the rate of change of the magnetic flux of the field through the area delimited by the circuit in the unit of time. Expressed as a formula, this is:

f.e.m.=−dφ(B)/dt

where Φ_{(B)} is the flux of magnetic induction.

According to a possible functional application of the second embodiment proposed, at least one shoe 9 is slideable and coupled to the rotor 8, with the interposition of at least one “crankshaft” type transmission mechanism 9a: each individual translational motion of the shoe 9 produces a rotation of the rotor 8 by the conversion of motion achieved by the transmission mechanism 9a.

It should be noted that, in order to steady the angular velocity of the shaft of the rotor 8, a flywheel is coupled to the shaft; this flywheel makes it possible to increase the moment of inertia, thus deadening abrupt changes in angular velocity and accumulating kinetic energy, in the event of rapid accelerations, which ensures the shaft (and therefore the rotor 8) is kept in rotation for a longer period of time.

According to a possible further embodiment, the dynamic component can be integral with a stem which is coupled to the closing door leaf 2.

The movement of the door leaf 2 thus produces a translational motion of the stem and, consequently, a movement of the dynamic component with respect to the static component, with generation of a voltage at the terminals 5 of the electrical winding 7.

It should be noted that, according to a further particularly functional embodiment which, moreover, requires little or no maintenance, the converter 4 for converting mechanical energy into electrical energy comprises at least one pad 10 which is made of piezoelectric material and is installed in a casing 11, which is integral with the bin 1 and is rigidly coupled to the casing 11.

The converter 4 furthermore comprises a striker 12 that can move inside the casing 11.

As a consequence of the movement of the bin 1 for use, emptying and/or maintenance, the striker 12 will be moving with respect to the casing 11, with consequent repeated impacts thereof on at least one piezoelectric pad 10.

The deformations of the pad 10 produce a voltage at its terminals 5; as in the previous cases, the terminals 5 are connected to the battery 3 for its recharging.

For more completeness and clarity of the present description, please note that a piezoelectric material is a material that has the property of generating a difference in electrical potential when it is subjected to a mechanical deformation. This effect is reversible and occurs on a scale in the order of nanometres.

The operation of a piezoelectric crystal is fairly simple: when an external pressure (or decompression) is applied, charges of opposite polarity occur on the opposite faces. In this way the crystal behaves like a condenser to which a potential difference has been applied. If the two faces are connected by means of an external circuit, then an electrical current is generated, and this is called a piezoelectric current. By contrast, when a potential difference is applied to the crystal, it expands or contracts.

According to a possible embodiment of undoubted practical and applicative interest, the striker 12 can be integral with a stem which is coupled to the closing door leaf 2; the movement of the door leaf 2 produces a translational motion of the stem and, consequently, at least one impact of the striker 12 on at least one pad 10 with generation of a voltage at the terminals 5 thereof.

By applying two pads 10 to the ends of the same casing 11, it is possible to take advantage of the impacts of the striker 12 which occur as a consequence of translational movements in both possible directions of motion inside the casing 11.

Arranging the pads 10 along the edge of the opening delimited by the door leaf 2 is not excluded; in this case the door leaf 2 will act as a striker whenever, by being closed, it impacts on the pads 10.

It should be noted furthermore that it is possible to provide a bin 1 according to the invention in which the converter 4 for converting mechanical energy into electrical energy is arranged at engagement prongs 13 for the movement arms of the truck that is to empty the bin.

The coupling of the ends of such arms with the respective seats of the prongs 13 provides the mechanical energy to be converted into electrical energy in the converter 4.

An optimal implementation of the bin 1 according to the invention has to allow a prolonged use of its electrical utilities (memory units, card and/or magnetic strip and/or chip readers, sensors, data transmission and reception apparatuses) powered only by the energy supplied by the batteries 3 (in the eventuality that the bin 1, for a long time, is not subjected to movements that are adapted to recharge the batteries 3); for this reason the battery 3 of accumulators comprises high-efficiency accumulators such as lithium accumulators, lithium ion polymer accumulators and the like.

It should be noted furthermore that, according to an applicative solution of exceptional practical interest, the bottom of the internal compartment of the bin 1 can comprise a fixed sheet which is rigidly coupled to the walls of the bin 1 and is surmounted by a yielding leaf which constitutes the visible surface of the bottom upon which the waste will rest.

In this case, respective converters 4 for converting mechanical energy into electrical energy can be interposed between the fixed sheet and the yielding leaf; actuated by the impact of waste, put into the bin 1, on the yielding leaf.

An equally interesting embodiment involves the arrangement of support feet 14 which are rigidly coupled to the base of the bin 1.

Suitable converters 4 for converting mechanical energy into electrical energy will, however, be interposed between the feet 14 and the base of the bin 1; lifting and setting down the bin 1 during the emptying operations will produce the actuation of the converters 4 thus ensuring recharging of the batteries 3.

It should be noted that all the embodiments proposed can be simultaneously (or individually or variously combined among them) applied to a same bin 1 so as to promote the recharging of the respective battery 3 of accumulators.

It should be noted that, downstream of the cited converters 4 and upstream of the batteries 3, it will be convenient to arrange suitable electrical components which are designed to filter and steady the electrical current so that the circulating current has characteristics which are such as to be suitable to recharge the battery 3.

The current trend in the management of waste disposal services, and particularly in the sector of collecting solid urban waste, is to use systems to remotely manage waste collection containers, i.e. to develop containers (such as the bin 1) that are technologically more advanced, provided with control systems and user interface. Such systems must necessarily be powered by means of electricity, which is currently supplied by means of dedicated batteries that are mounted directly on the container, either of long duration or powered/recharged by apparatuses that make use of solar energy. The batteries, which have to function under critical environmental conditions, are very expensive; this produces an increase in costs whose sustainment the community must accept.

The bin 1 according to the invention, by using current and future technologies for energy harvesting, makes it possible to generate electricity by taking advantage of the forces applied to some of its components, during the steps of emptying, movement, and actuation by suitable operator machines, or simply during the steps of depositing waste, which normally imply the opening and closing, of the door leaf 2 or of other parts of the bin 1 by means of actuation.

By analyzing the operations of emptying and washing out containers by operator machines/vehicles, the following steps can be listed:

a) Hitching the container;

b) Lifting the container;

c) Opening the closing door leaves 2 to initiate emptying;

d) Shaking the container to ensure a complete emptying;

e) Repositioning the container in its original position.

It is evident that the energy content of these operations (kinetic energy of the moving parts, potential energy of the bin 1 when it is lifted off the ground etc.) can be effectively exploited by the bin 1 according to the invention.

Similarly, also during the operations of depositing the waste in the bin 1 according to the invention by users, respective steps can be listed:

a) Opening the container by means of pressure on the pedal or on another opening system;

b) Opening the container with an optional mechanical key;

c) Manually opening the depositing covers or flaps;

d) Depositing the waste inside the container;

e) Closing the container by releasing the devices or by reversing the actions in a), b), c).

It is therefore evident that also during depositing it is possible to exploit the forces applied in order to produce electrical energy with which the batteries 3 can be recharged by means of the converters 4 which are installed in the bin 1.

Advantageously, the bin 1 according to the invention solves the above-mentioned problems, since it does not require specific recharging operations.

Positively, the bin 1 according to the invention has a low weight, since the battery of accumulators 3 can be small in size given that its charging will be ensured by the continual recharging operations that are actuated by the converter 4.

Usefully, the reduction of the encumbrances of the batteries 3 explained above ensures a large internal volume of the bin 1.

It should be noted that the invention can be used and implemented on all types of bins which are adapted to collect waste, including wheeled containers independently of their volumes (with particular reference to containers on trolleys with internal volumes of from 120 to 360 litres), wheeled bins independently of their volumes (with particular reference to wheeled containers with internal volumes of from 1,000 to 1,700 litres), static bins and waste banks (e.g. bottle banks) independently of their volumes (with particular reference to containers on trolleys with internal volumes of from 2,000 to 3,500 litres), buried containers, or industrial containers/skips independently of their volumes (with particular reference to containers on trolleys with internal volumes of from 4,000 to 40,000 litres).

Of equal interest is the particular characteristic of the bin 1 according to the invention of being autonomous in energy terms, thus making it possible to develop its management according to the methods which are typical of “technological” containers (if possible low-cost) i.e. for the following “secondary” purposes:

a) Application and monitoring, directly on the container, of the exact tariff for the deposit made (the cost of the waste collection and disposal service can then be directly linked to the quantity of waste deposited);

b) Registration and verification of user/client;

c) Ongoing point of communication available to the user for issuing and reading messages, including alarm messages and public information announcements;

d) Acquisition of data about the container (any breakages etc.) and about the waste contained therein.

The invention thus conceived is susceptible of numerous modifications and variations, all of which are within the scope of the appended claims; in addition, all the details may be replaced by other, technically equivalent elements.

For example the converter 4 could be of the electrostatic type, i.e. a harmonic oscillator (caused to move by all external actions applied to the bin 1) which is associated with one of the armatures of a condenser which, as a consequence of the oscillations, is adapted to generate a change in capacitance with consequent induction of circulation of electrical current (and presence of a voltage at the terminals, if the circuit is interrupted).

The adoption of different converters 4 is in any case not excluded (which converters are designed to take advantage of mechanical movements and oscillations of the bin 1 or of a part thereof) that are adapted to convert mechanical energy into electrical energy on the basis of the widest possible variety of physical and chemical phenomena.

In the embodiments illustrated, individual characteristics shown in relation to specific examples may in reality be interchanged with other, different characteristics, existing in other embodiments.

Moreover, it should be noted that anything found to be already known during the patenting process is understood not to be claimed and to be the subject of a disclaimer.

In practice the materials employed, as well as the dimensions, may be any according to requirements and to the state of the art.

Where the technical features mentioned in any claim are followed by reference signs, those reference signs have been included for the sole purpose of increasing the intelligibility of the claims and accordingly, such reference signs do not have any limiting effect on the interpretation of each element identified by way of example by such reference signs.

1.-13. (canceled)

14. A bin for the activity of waste control and management, the bin comprising: an upper opening for the depositing of waste into an internal compartment for containment, the upper opening being delimited by at least one respective closing door leaf, comprising at least one management and control unit for commanding respective sensors and operative assemblies, at least one battery for powering the unit and the circuits controlled by it, and at least one converter for converting mechanical energy into electrical energy which has output terminals connected to the battery for its recharging, the movement of at least a portion of the bin for use, emptying and maintenance thus causing the activation of the converter and the recharging of the at least one battery.

15. The bin according to claim 14, wherein the converter for converting mechanical energy into electrical energy comprises a static component which is integral with the bin and is provided with a circuit made of ferromagnetic material on which an electrical winding is installed, and a dynamic component which is constituted by a magnet movable inside a respective cavity of the ferromagnetic circuit of the static component, as a result of the movement of the bin for use, emptying and maintenance, the dynamic component being caused to move with respect to the static component with consequent electromagnetic induction in the electrical winding and establishment of a voltage at the terminals of the winding, the terminals being connected to the battery for its recharging.

16. The bin according to claim 15, wherein the movable magnet is a slider adapted for linear translational movement, according to a consecutive motion of advancement and retraction, inside the cavity of the static component, the translational movement thus producing a change in the magnetic flux with consequent induction, at the terminals of the winding, of a voltage.

17. The bin according to claim 15, wherein the movable magnet is a rotor which is adapted for rotation, about its own axis, inside the cavity of the static component, the rotation thus producing a change in the magnetic flux with consequent induction, at the terminals of the winding, of a voltage.

18. The bin according to claim 17, wherein at least one slideable shoe is coupled to the rotor, with the interposition of at least one “crankshaft” type transmission mechanism, a translational movement of the shoe thus producing a rotation of the rotor.

19. The bin according to claim 17, wherein on the shaft of the rotor, and integral with it, a flywheel is coupled for increasing the moment of inertia and, therefore, steady the angular velocity of rotation.

20. The bin according to claim 15, wherein the dynamic component is integral with a stem which is coupled to the closing door leaf, the movement of the door leaf thus producing a translational movement of the stem and, consequently, a movement of the dynamic component with respect to the static component, with generation of a voltage at the terminals of the electrical winding.

21. The bin according to claim 14, wherein the converter for converting mechanical energy into electrical energy comprises at least one pad which is made of piezoelectric material and is installed in a casing integral with the bin and a striker that can move inside the casing, as a result of the movement of the bin for use, emptying and maintenance, the striker being caused to move with respect to the casing with consequent repeated impacts thereof on the piezoelectric pad, the deformations of the pad thus producing the establishment of a voltage at its terminals, the terminals being connected to the battery for its recharging.

22. The bin according to claim 21, wherein the striker is integral with a stem which is coupled to the closing door leaf, the movement of the door leaf thus producing a translational movement of the stem and, consequently, at least one impact of the striker on the at least one pad with generation of a voltage at the terminals thereof.

23. The bin according to claim 14, wherein the converter of mechanical energy into electrical energy is arranged at the prongs for engaging with the movement arms of the vehicle that is provided for emptying, the coupling of the ends of the arms with the respective seats of the prongs providing the mechanical energy to be converted into electrical energy at the converter.

24. The bin according to claim 14, wherein the battery comprises high-efficiency accumulators such as lithium accumulators, accumulators with lithium ions and polymers and the like.

25. The bin according to claim 14, wherein the bottom of the internal compartment comprises a fixed sheet which is rigidly coupled to the walls of the bin and is surmounted by a yielding leaf which constitutes the visible surface of the bottom, upon which the waste will rest, at least one converter for converting mechanical energy into electrical energy being interposed between the fixed sheet and the yielding leaf, which converter is actuated by the impact of the waste, put into the bin, on the yielding leaf.

26. The bin according to claim 14, wherein the supporting feet are rigidly coupled to the base of the bin with at least one converter for converting mechanical energy into electrical energy being interposed therebetween, the lifting and setting down of the bin during the emptying operations thus producing the actuation of the at least one converter for converting mechanical energy into electrical energy.
